(19) United States
(12) Patent Application Publication
(10) Pub. No.: US 2021/0235042 A1
(43) Pub. Date: Jul. 29, 2021

(54) USER-PRODUCED VIRTUAL EVENT-PRODUCTION PLATFORM FOR PARTICIPATORY SOCIAL GATHERING AND THE MODEL OF SHARING ECONOMY THEREOF

(71) Applicant: Javier Feria, Chino, CA (US)

(72) Inventor: Javier Feria, Chino, CA (US)

(21) Appl. No.: 17/161,652

(22) Filed: Jan. 28, 2021

Related U.S. Application Data
(60) Provisional application No. 62/966,808, filed on Jan. 28, 2020.

(51) Int. Cl. H04N 7/15; G06Q 20/08

(52) U.S. Cl. CPC H04N 7/157; G06Q 20/085

(57) ABSTRACT

A sharing economy business online platform where a user may create and/or manage a virtual event of social gathering.

### CROSS-REFERENCE TO RELATED APPLICATIONS

This application claims priority to, and is a non-provisional application of, U.S. Provisional Pat. No. 62/966,808, filed on Jan. 28, 2020, now pending, which is hereby incorporated by reference in its entirety.

### FIELD OF THE DISCLOSURE

The present disclosure relates to an online platform and, more particularly, an online platform involving virtual social gathering, participatory virtual gathering, and/or virtual event-production.

### BACKGROUND OF THE DISCLOSURE

People are known to gather in person for a specific theme or occasion; it can be to celebrate or to gather in memory of a certain person, thing, or event. For example, when a person passes a way his or her loved one would often call together some people to attend a funeral service for the deceased.

People are also known to gather online for a specific theme or occasion. For example, people create online chat rooms or group SMS message groups to plan a funeral or to discuss mutual interest in a sports team.

It is also known that an in-person event can be telecasted live on television or live-streamed online so that an online audience or online “followers” can somewhat experience the event being telecasted or live-streamed.

There is a continuing need for new ways to create a participatory experience for an online audience.

There is a need for a method to facilitate virtual event-production that allows for creation of user-produced virtual gathering events.

There is a need for a platform of sharing economy where a user and/or other operators may generate revenue from creating and/or managing a live-streamed virtual event for online participants.

There is a need for a marketing method/tool allowing an event producer to scale-up an event to reach a broader audience and to increase its revenue stream.

All referenced patents, applications and literatures are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply. The disclosed embodiments may seek to satisfy one or more of the above-mentioned needs. Although the present embodiments may obviate one or more of the above-mentioned needs, it should be understood that some aspects of the embodiments might not necessarily obviate them.

### SUMMARY OF THE DISCLOSURE

It should be noted that the illustrations in the drawing figures may be in simplified form and might not be to precise scale and might not be the ultimate commercialized representation of the various features of the contemplated embodiments. Also, the term virtual event or virtual environment is not limited to a 3D graphical rendition, it can include 2D, 4D, photographic, cinematic, augmented reality, or other types of online environment known now and those that would be developed in the future as the technology progresses.

Most, if not all, of the drawing figures relate to the specific implementation of a virtual memorial service. It should be particularly noted that the same idea can be implemented for other event types such as birthday parties, graduation parties, music concerts, religious services and meetings, political rallies, family gatherings, fundraiser, and any social gathering.

Any such embodiments can or cannot require the actual identity of each participant be shown or revealed. In most embodiments, the platform requires each attendee's actual and real identity be shown in the virtual gathering. In some embodiment, the platform can allow each attendee to use a made-up alias to identify himself or herself.

In one embodiment, a contemplated virtual 3-D memorial service environment can be created for multitude of invitees to gather at a designated time. The invitees (represented by an avatar) can interact with other avatars (some of which can be controlled and/or designated to a family member, the minister, other invitees/attendees) within a specifically designated virtual space and/or within a specifically designated scheduled time frame.

In one embodiment, all of the avatars can be controlled by a real person in real time and presents that person.

In another embodiment, some of the avatars can be controlled by the computer and is not controlled by a real person in real time.

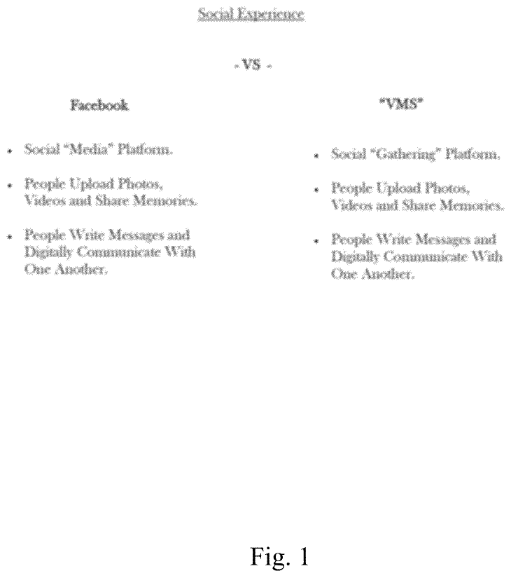

FIG. 1 illustrates a social gathering aspect of one embodiment, according to one embodiment of the disclosure.

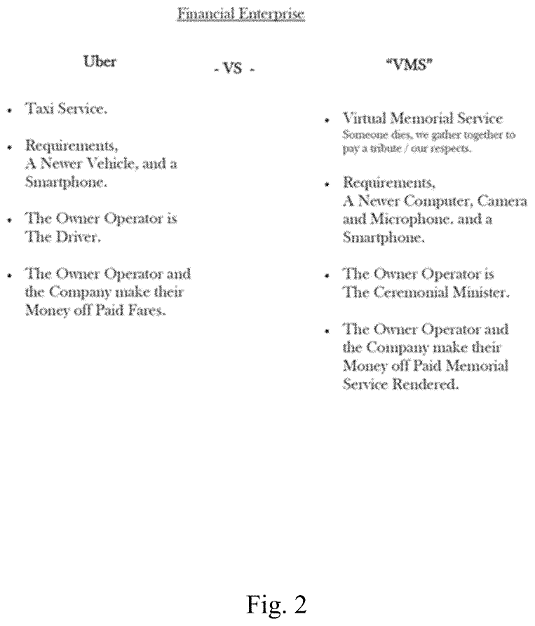

FIG. 2 illustrates one implementation where the virtual memorial service is operated/managed by a ceremonial minister. The platform can provide a minister the tools needed to easily produce a virtual memorial service according to one embodiment of the disclosure. One way for a minister to generate revenue can by collecting payment from the family of the deceased. Another way for the minister to generate revenue can be collecting payments from the attendees for virtual floral arrangements.

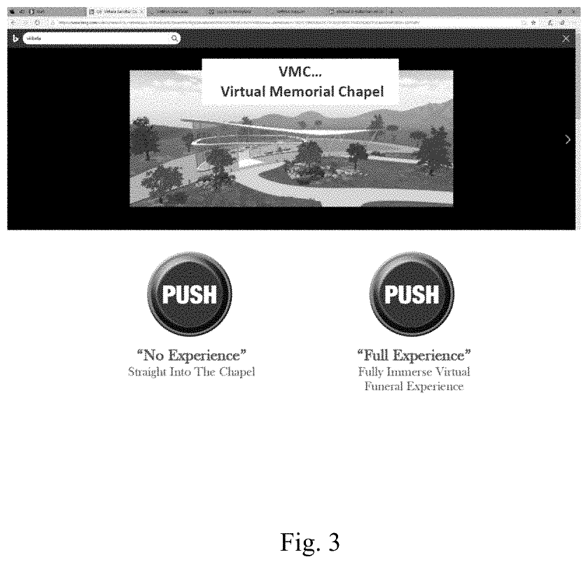

FIG. 3 illustrates an exemplar user interface (screenshot) of the platform, according to one embodiment of the disclosure, when a real person has decided to go to a designated website to attend the memorial service he/she is invited to. In this example, he/she was given a specific time and date for the memorial service. At this screen, the user is given the option of “no experience,” which means he/she would enter without the ability to interact with anyone, or the option of “full experience,” where he/she would enter with the ability to interact with other avatars.

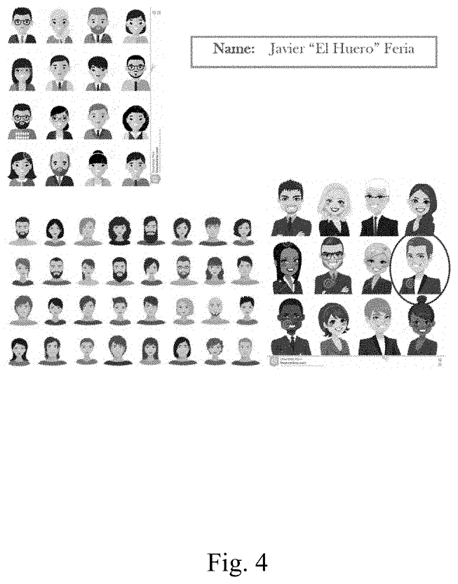

FIG. 4 illustrates an exemplar user interface (screenshot) of the platform, according to one embodiment of the disclosure, where the user can be asked to select an avatar to represent himself/herself.

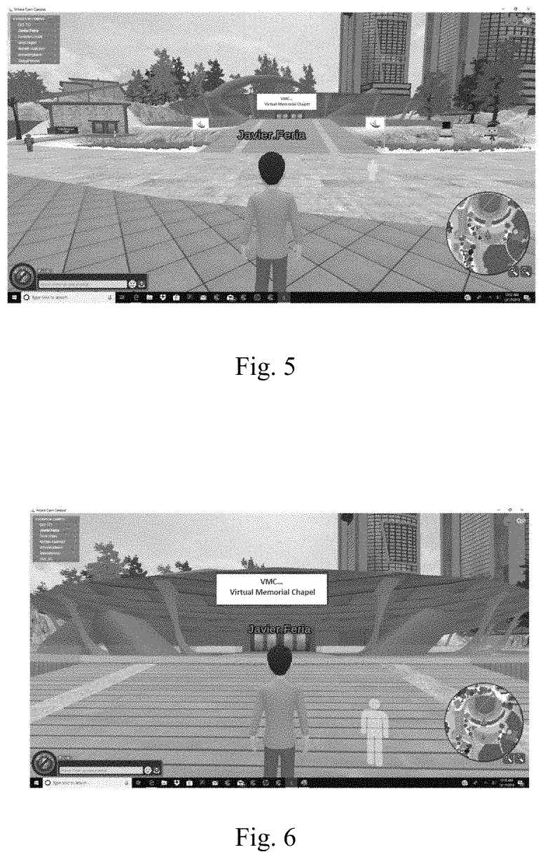

FIG. 5 illustrates an exemplar user interface (screenshot) of the platform, according to one embodiment of the disclosure, where the user sees his avatar within a virtual space (e.g., a public square with a memorial chapel in front of him) and he/she can selectively control where the avatar moves to.

In some embodiment, the avatar can meet and interact with other avatars in this space.

FIG. 6 shows the same avatar of FIG. 5 and the avatar has now moved closer to the entrance of the memorial chapel. In some other embodiments, such as when the user has selected “no experience,” the avatar automatically moves to the entrance of the chapel and the user cannot control the avatar's movement.

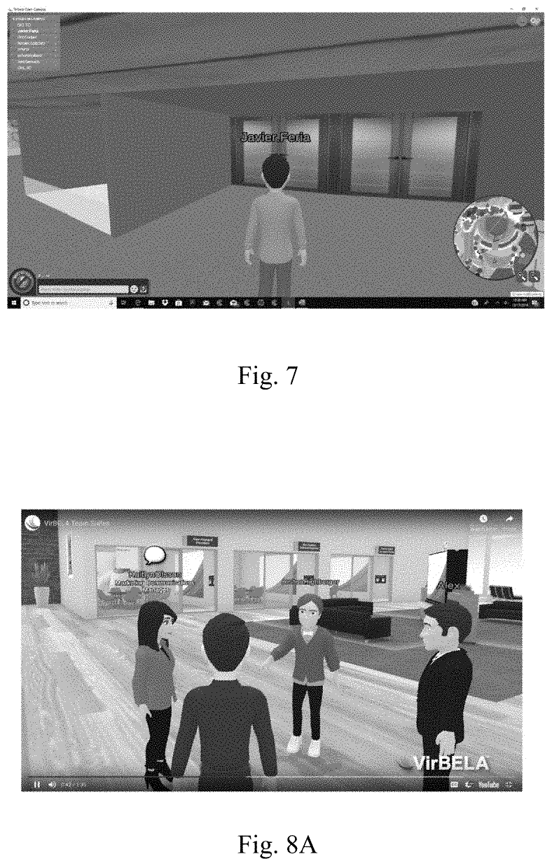

FIG. 7 illustrates an exemplar screenshot of the user interface of the platform, according to one embodiment of the disclosure, where the user's avatar is now ready to enter the memorial chapel.

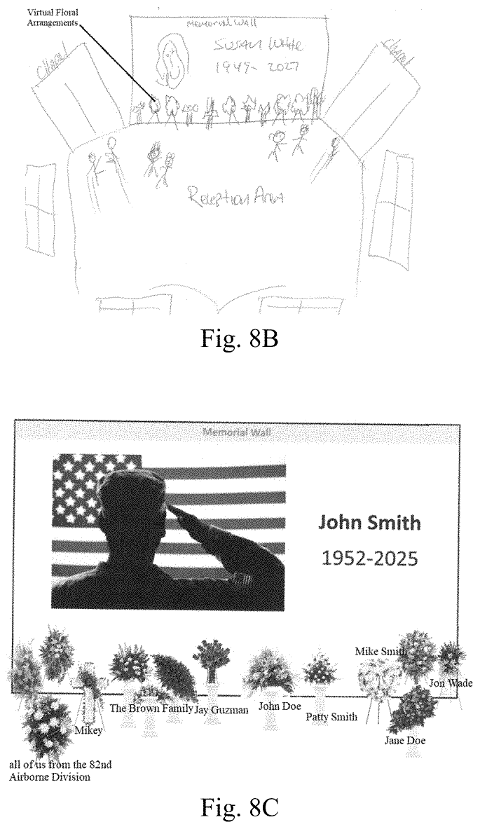

FIG. 8A illustrates another public space within the memorial chapel, according to one embodiment of the disclosure, where the avatar can interact with other avatars in the public space. For example, one may see the name or identity of other avatars in this space and choose to move closer to a particular avatar to start a conversation. The contemplated conversation can be in the form of instant-messaging on the screen, or voice live exchanges (e.g., VOIP, recorded voice-clips).

In one example, a user who is attending the virtual memorial service can meet and greet a family member whom he/she has not seen for a long time. Here in this virtual space prior to the starting time of the memorial service, they can chat and catch up. In one embodiment, their discussion is private and cannot be seen or heard by others (e.g., one-on-one conversation). In another embodiment, their discussion can be made public and can be seen or heard by others in the same virtual reception area.

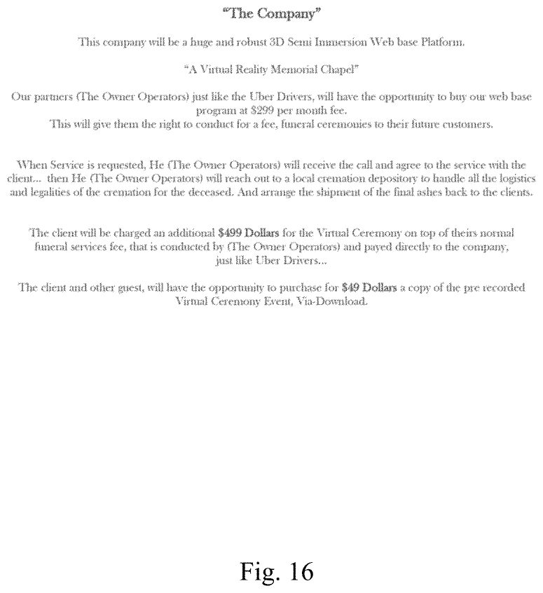

FIGS. 8B and 8C illustrate one embodiment where a memorial wall can be provided in the reception area. Here, where the avatars gather, a wall is dedicated to the deceased. This can be a themed wall such that the owner/operator of the event can select specific themes suitable for the deceased. In the example of FIG. 16C, a veteran/military theme is selected. Against the memorial wall are placed virtual flowers purchased by attendees/invitees of the event. Names of those who purchased the flower can be seen by any avatar that “walks” up closer to the memorial wall.

The memorial wall can also play slideshows of photographs or video clips.

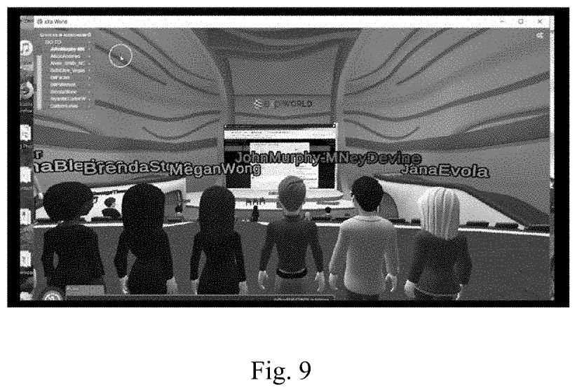

FIG. 9 illustrates an example showing the view of a user named “John Murphy.” John is now in the chapel with other avatars. He can also see the names of the people who those avatars represent. He can adjust his view and try to see if he recognizes anyone else in attendance, according to one embodiment of the disclosure.

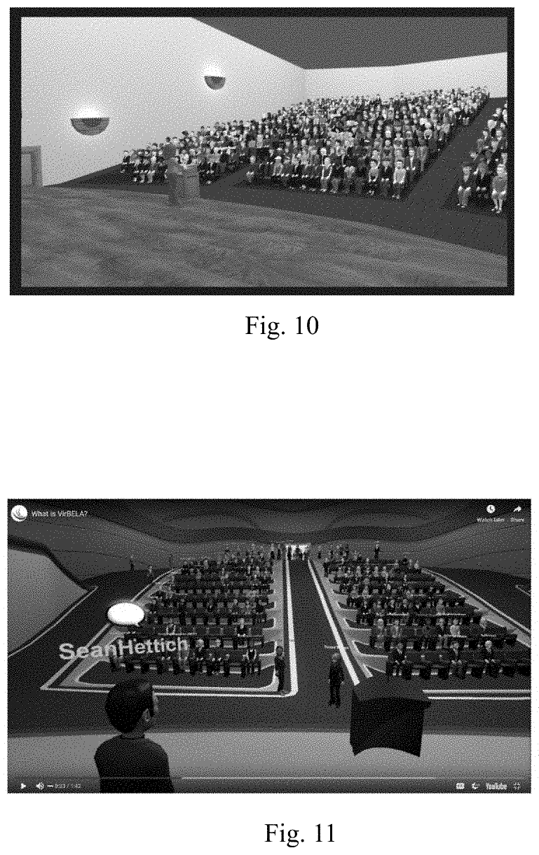

FIG. 10 illustrates a view of the “owner/operator” of the virtual event, according to one embodiment of the disclosure. The owner/operator can be a ceremonial minister, as described above in FIG. 2. This ceremonial minister is a real person and can be represented by an avatar.

In another embodiment, the owner/operator can be a family member of the deceased. This family can be represented by an avatar and he/she in turn can hire or somehow share revenue with a ceremonial minister.

FIG. 11 illustrates a view of “owner/operator” of the virtual event in one embodiment. Here in this example, the owner/operator is Sean Hettich. He/she can look into the virtual audience and see the name of each avatar that is attending the virtual memorial service. He can also optionally interact with any avatar in the chapel, according to one embodiment of the disclosure.

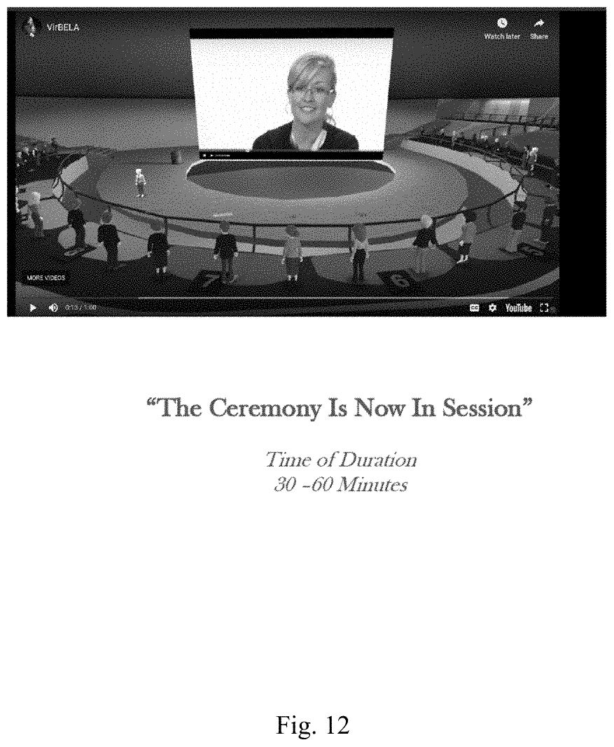

FIG. 12 illustrates a user interface for an attendee, according to one embodiment of the disclosure, where the memorial service is in session and a video clip is being played. The video clip can be pre-recorded or live streamed. The video clip can be generated or created by the ceremonial minister, or by a family member, or both.

In one embodiment, the owner/operator would gather/prepare/produce contents of the ceremony ahead of time and uploads them onto the platform. The owner/operator can optionally use online tools available on the platform to arrange and edit each content piece and organize them on a timeline and then play the content on the day of the event. Essentially the platform can be an online editing tool for the owner/operator to produce the virtual memorial service. At the designated time and day of the virtual memorial service, the owner/operator can play various pieces of prepared content and can also speak or appear on the screen live. In one way, this allows a ceremonial minister to prepare and produce contents ahead of time, and on the day of the memorial service he may only need to spend 30 minutes of time in managing the event.

In one embodiment, a friend of the deceased who is invited to speak at the ceremony can make arrangement with the owner/operator ahead of time to speak or appear on the screen live, if this friend has access to necessary hardware (e.g., microphone and video camera).

In another example, the owner/operator can control when to allow any avatar in the audience to “walk up” to the microphone and speak. In such instances, a user may move his avatar toward the microphone and speak. Everyone attending-virtually can see the name of the person this particular avatar represents.

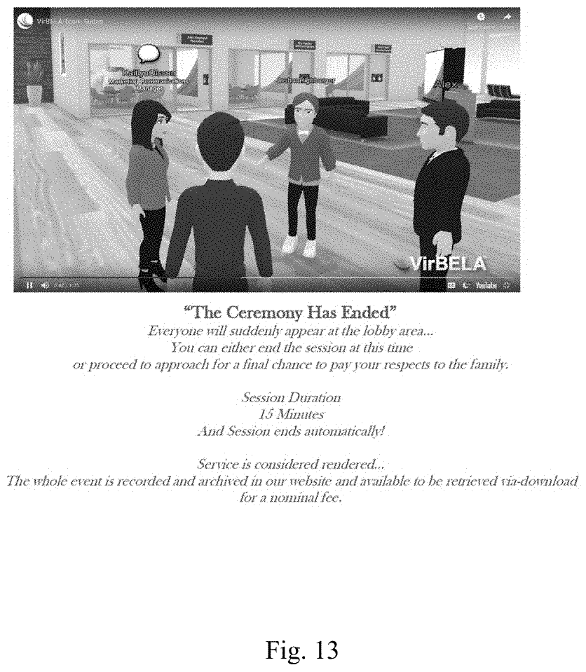

FIG. 13 illustrates a view during a point in time where according to schedule, the ceremony has ended and the avatars are now congregating in the reception area, according to one embodiment of the disclosure. Here, some of the avatars can choose to stay around to interact with other avatars.

A business method is also contemplated where a revenue stream can be generated by any of the following transactions in this virtual memorial service platform:
Users/attendees can have the option to donate real money (e.g., via credit cards, ACH transfers, VENMO, APPLE PAY) to the family of the deceased, or to a designated charity.
User/attendees can have the option to purchase virtual floral arrangement using real money (e.g., via credit cards, ACH transfers, VENMO, APPLE PAY), and the virtual floral arrangement would be displayed for all to see in the reception area where the memorial wall is, showing the names of the donors.
Family of the deceased pay a ceremonial minister for his/her services.

In one embodiment, various parties to the platform (e.g., platform operator, owner/operator of the event, family of the deceased, designated charity) can agree ahead of time prior to the event on how the revenue is to be split among the parties. This agreement can be part of the profile set-up when each of the parties signs up to the platform. For example, there may be a setting where the parties agree that 10% of gross donation/proceeds would go to the website operator.

Each party (e.g., the ceremony minister) who sign up to the platform can have a public profile (may include customer reviews) viewable by others. Optionally, each party's profile or identity can be linked to his/her social media profile (e.g., FACEBOOK, INSTAGRAM, LINKEDIN).

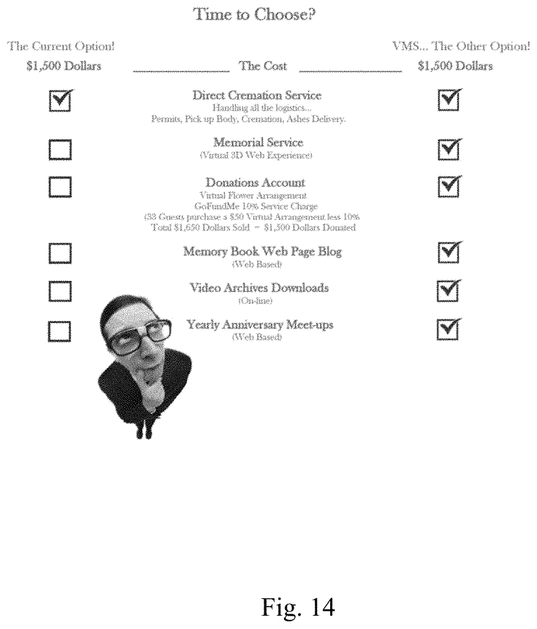

FIG. 14 illustrates additional services that can add value to the platform, such as:
Yearly anniversary virtual meet ups (invitations are sent for all attendees to return).
Downloadable event video archive.
Memory book web page blog.

In particular, FIG. 14 analyzes the feasibility of the business model where in one embodiment the virtual memorial service (which can include the actual direct cremation service) can cost the family about the same or less than the cost of a similar traditionally direct cremation service. In one embodiment, this can be possible due to the revenue stream generated between the various parties. For example, 80-90% of the proceeds from virtual flowers donations may be sufficient to offset the cost of the virtual memorial service.

In another example, the platform may allow third party advertisers to purchase advertising space in the virtual environment. This can increase the revenue stream and help pay for the event.

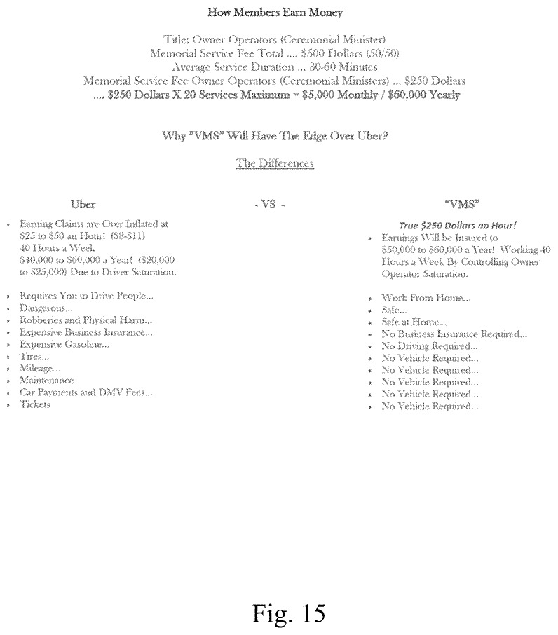

FIG. 15 illustrates one calculation of a contemplated revenue stream model. In one embodiment, the platform owner can selectively control event owner/operator saturation (e.g., the ceremony ministers) to ensure adequate earning per event owner/operator.

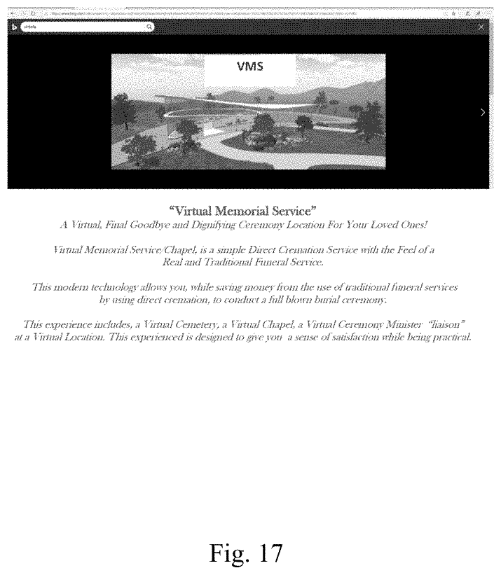

FIGS. 16 and 17 illustrate other calculations of contemplated revenue stream models. Note that in this particular model, the platform operator has minimal involvement in each virtual memorial service. The platform can be self-sufficient where each owner/operator is doing most of the organizing and production. In turn, each owner/operator is incentivized with a revenue stream.

In some embodiments, this platform can allow friends and family from far away to meaningfully attend a memorial service where they may also interact with friends and family that they know. In other embodiments, this platform can allow for a much larger audience to pay respect to a deceased public figure.

In one embodiment, a pre-arranged setting of the platform may waive all or some service fees to the family when the revenue stream from other parties reaches a certain threshold.

In one embodiment, this virtual memorial service can take place prior to, concurrent with, or after the actual memorial service in real life.

In yet another embodiment, this can be for pet funeral where the owner of the deceased pet may not have otherwise hold a memorial service for the deceased pet. This novel business method particularly targets the psychologies of certain segments of event producers or certain segments of event attendees.

In one embodiment, the platform is membership-based where the members are the ceremonial ministers.

In other event types, virtual floral arrangements can be replaced with virtual champagne bottles, virtual gifts, etc.

Many alterations and modifications may be made by those having ordinary skill in the art without departing from the spirit and scope of the disclosed embodiments. Therefore, it must be understood that the illustrated embodiments have been set forth only for the purposes of example and that it should not be taken as limiting the embodiments.

It should be apparent to those skilled in the art that many more modifications besides those already described are possible without departing from the disclosed concepts herein.

1. A sharing economy business online platform, comprising:
a server-based computer program providing said online platform to be displayed via a device having a screen where the device is connected online;
make available user accounts each with an avatar for a plurality of human participants to sign up and participate in a virtual event on the platform;

2. The online platform as recited in claim 1, where the plurality of human participants can create and/or manage his or her avatar in the virtual event.

3. The online platform as recited in claim 1, make available a host account each with or without an avatar for a human participant to sign up and host the virtual event on the platform.

4. The online platform as recited in claim 1, make available in the platform for money to exchange between the host account and the user accounts.

5. The online platform as recited in claim 1, wherein the virtual event is a funeral.

6. The online platform as recited in claim 1, make available in the platform for avatars to have private or open conversations.

7. The online platform as recited in claim 1, make available in the platform a space for avatars to leave messages.
